(19) United States
(12) Patent Application Publication
(10) Pub. No.: US 2026/0365779 A1
(43) Pub. Date: Nov. 19, 2026

(54) THERMOPLASTIC POLYURETHANE MATERIALS HAVING GOOD ELASTIC RECOVERY AND LOW SOFTENING TEMPERATURE

(71) Applicant: Huntsman International LLC, The Woodlands, TX (US)

(72) Inventors: Conny NIJS, Tienen (BE); Rene Alexander KLEIN, Tienen (BE); Martino DOSSI, Tienen (BE); Jan Marc VANDENBROECK, Tienen (BE)

(21) Appl. No.: 19/103,262

(22) PCT Filed: Aug. 16, 2023
(86) PCT No.: PCT/EP2023/072601

§ 371 Date: Feb. 12, 2025

(30) Foreign Application Priority Data
Aug. 17, 2022 (EP) 22190736.3

(51) Int. Cl. C08G 18/66; C08G 18/24; C08G 18/32; C08G 18/42; C08G 18/76; C09J 175/06

(52) U.S. Cl. CPC C08G 18/664; C08G 18/246; C08G 18/3215; C08G 18/4238; C08G 18/7671; C09J 175/06

(57) ABSTRACT

The present invention relates to soft thermoplastic polyurethane materials with very good elastic recovery properties (>92%) in combination with low softening points and good adhesive properties towards supporting materials such as textile.

### FIELD OF INVENTION

The present invention relates to soft thermoplastic polyurethane materials with very good elastic recovery properties (>92%) in combination with low softening points and good adhesive properties towards supporting materials such as textile.

The invention further relates to a reactive mixture and processing method for the preparation of the soft thermoplastic polyurethane materials.

The invention further relates to the use of the soft thermoplastic polyurethane materials as an adhesive where low melting and high elasticity recovery is a requirement for example as an adhesive coating in sew free apparel.

### BACKGROUND OF THE INVENTION

Over the last years, there has been a growing interest and market for sew free apparel and the use of suitable adhesive materials which allow stitch free assembling, more in particular for application in delicate fabrics, like in comfort athletic clothing. These stitch free applications require adhesives which need to be applied at low processing temperatures and need to show a very good elastic recovery. Thermoplastic polyurethanes (TPU) are very suitable seen their very good elastic properties but the softening point and hence the processing temperature of many commercially available TPU grades is too high for application to delicate fabrics.

Good elastic properties in TPU are generally obtained via the phase separation of hard and soft blocks, in combination with an ordering of the hard blocks via H-bonding. As such, the hard blocks form physical cross-links between the linear TPU chains, resulting in good elastic properties. This mechanism usually requires a certain (minimum) concentration of hard blocks in the TPU composition. Increasing the hard block content of a TPU however, also increases the softening point of the TPU.

Additionally, the market wants to avoid the use of plasticizers for environmental reasons.

It is therefore an aim of the invention to develop a TPU based adhesive suitable for use in delicate textiles wherein the TPU based adhesive is having beside a very good elastic recovery of >92% a low processing temperature and wherein the use of plasticizers is avoided and/or eliminated.

### AIM OF THE INVENTION

It is a goal of the invention to develop a soft thermoplastic polyurethane (TPU) composition with very good elastic recovery (>92%) in combination with low softening point (>80 °C and <140 °C) and hence low processing temperatures.

The above goal is achieved by the TPU materials according to the present invention wherein the TPU material comprises a high concentration of “soft” segments (preferably amorphous) and a low amount of low molecular weight “hard” segments.

More in particular, the TPU materials according to the present invention comprise a significant amount of “soft” segments (preferably amorphous soft segments) having an average degree of branching of greater than 0.4 to less than or equal to 0.8, preferably from 0.4 to 0.6 calculated as the amount of hydrocarbon side chains per polyester (or polyether) unit present in the polyurethane backbone in combination with a low amount of hard segments originating from chain extender compounds having a number average molecular weight in the range 60-400 g/mol.

It is a further goal to develop a reactive mixture to make the TPU materials according to the invention and a method for making the TPU materials according to the present invention.

### DEFINITIONS AND TERMS

In the context of the present invention the following terms have the following meaning:
1) The isocyanate index or NCO index or index is the ratio of NCO-groups over isocyanate-reactive hydrogen atoms present in a formulation, given as a percentage:

$$\frac{[ NCO ] \times 100}{[ active hydrogen ]} ( \% )$$

In other words, the NCO-index expresses the percentage of isocyanate actually used in a formulation with respect to the amount of isocyanate theoretically required for reacting with the amount of isocyanate-reactive hydrogen used in a formulation.
It should be observed that the isocyanate index as used herein is not only considered from the point of view of the actual polymerisation process preparing the material involving the isocyanate ingredients and the isocyanate-reactive ingredients. Any isocyanate groups consumed in a preliminary step to produce modified polyisocyanates (including such isocyanate-derivatives referred to in the art as prepolymers) or any active hydrogens consumed in a preliminary step (e.g. reacted with isocyanate to produce modified polyols or polyamines) are also taken into account in the calculation of the isocyanate index.
2) The term “polyurethane”, as used herein, is not limited to those polymers which include only urethane or polyurethane linkages. It is well understood by those of ordinary skill in the art of preparing polyurethanes that the polyurethane polymers may also include allophanate, carbodiimide, uretidinedione, and other linkages in addition to urethane linkages.
3) The term “thermoplastic” is used herein in its broad sense to designate a material that is reprocessable at an elevated temperature above the melting temperature of the polymer, whereas “thermoset” designates a polymer material that exhibits high temperature stability without such reprocessability at elevated temperatures. A thermoplastic material will lose its structural integrity upon heating above its melting temperature and will start to flow.
4) The term “elastomeric material” or “elastomer” or elastic material” designates a material which, at room temperature, is capable of recovering substantially in shape and size after removal of a deforming force.
5) The term “average nominal functionality of a composition” (or in short “functionality of a composition”) is used herein to indicate the number average of functional groups per molecule in a composition. It reflects the real and practically/analytically determinable number average functionality of a composition. In case of a blend of materials (isocyanate blend, polyol blend, reactive mixture) the “average nominal functionality” of the blend is identical to the “molecular number average functionality” calculated via the total number of molecules of the blend in the denominator. It thereby requires using the real and practically/analytically determinable number average functionality of each of the chemical compounds of the blend. In case of a reactive mixture the molecular number average functionality of the complete reactive mixture should be taken into account (thus including all functional groups originating from isocyanate and isocyanate reactive compounds).
6) The term “hydroxyl functionality” of a composition refers to the number average of hydroxyl functional groups in that composition (average nominal hydroxyl functionality). The term “isocyanate functionality” of a composition refers to the number average of isocyanate functional groups in that composition (average nominal isocyanate functionality). The term “iso-reactive functionality” of a composition refers to the number average of isocyanate reactive hydrogen containing functional groups in that composition typically originating from amines and polyols (average nominal iso-reactive functionality).
7) The term “difunctional” as used herein means that the average nominal functionality is about 2. A difunctional polyol (also referred to as a diol) refers to a polyol having an average nominal hydroxyl functionality of about 2 (including herein values in the range 1.9 up to 2.1). A difunctional isocyanate refers to an isocyanate composition having an average nominal isocyanate functionality of about 2 (including herein values in the range 1.8 up to 2.2).
8) The expression “Reaction system”, “Reactive formulation” and “Reactive mixture” as used herein refers to a combination of reactive compounds used to make a polymer. In case of a polyurethane (including thermoplastic polyurethane) comprising polymer the polyisocyanate compounds are usually kept in one or more containers separate from the isocyanate-reactive compounds before bringing these compounds together to form a reactive mixture.
9) The term “room temperature” refers to temperatures of about 20 °C, this means referring to temperatures in the range 18 °C to 25 °C. Such temperatures will include, 18 °C, 19 °C, 20 °C, 21 °C, 22 °C, 23 °C, 24 °C and 25 °C.
10) Unless otherwise expressed, the “weight percentage” (indicated as % wt or wt %) of a component in a composition refers to the weight of the component over the total weight of the composition in which it is present and is expressed as percentage.
11) Unless otherwise expressed, “parts by weight” (pbw) of a component in a composition refers to the weight of the component over the total weight of the composition in which it is present and is expressed as pbw.
12) “Tensile set” as referred to herein is a measure for the elastic recovery herein and is expressed in %. The elastic recovery is the ratio of the recovered length of a polymer sample after it has been stretched and released, to the original length of the unstretched sample. Elastic recovery is expressed in percentage. Tensile set or permanent set is the ratio of the unrecovered length of a polymer sample after it has been stretched and released, to the original length of the unstretched sample. Permanent set is thus (100-elastic recovery), also in %. Elastic recovery was measured after 3 cycles of 100% elongation with 15 s lag time after 100% elongation, and 15 s relaxation time at the end of each cycle.
13) The term “Melting Temperature” or “Tₘₑₗₜ” as used herein refers to the temperature or temperature range at which a polymer material changes state from solid to liquid. At the “Melting Point” the solid and liquid phase exist in equilibrium.
14) The term “Softening Temperature” or “T_{softening}” as used herein refers to a temperature or temperature range at which a polymer material softens and start to experience noticeable changes in physical properties but wherein the polymer is still in its solid state (T_{softening}<Tₘₑₗₜ). The softening point may be measured via either Thermo Mechanical Analysis (TMA) from 25 °C to 150 °C at 10 °C/min and 0.1N, or via a rheological oscillation protocol from −10 °C to 160 °C at 5 °C/min and 1 Hz using a 25 mm plate-plate configuration. In the latter method the G′-G″ cross-over temperature is defined as the softening point of the material.
15) The term “degree of branching” is referring to the regular or irregular attachment of side chains to the polyurethane backbone chain. It is defined herein as the number of hydrocarbon side chains per polyester (or polyether) unit present in the polyurethane backbone. Herein “per polyester (or polyether) unit” means per polyester (or polyether) functional group in the polyurethane backbone.
16) The term “hardblock” refers to 100 times the ratio of the amount (in pbw) of polyisocyanate+isocyanate-reactive compounds having a molecular weight less than 400 g/mol over the amount (in pbw) of all polyisocyanate+all isocyanate-reactive compounds used. The hardblock content is expressed in %.
17) The “number average molecular weight” of the high molecular weight isocyanate-reactive compound described herein may be calculated from the measured hydroxyl value of the high molecular weight isocyanate-reactive compound, assuming a hydroxyl functionality of 2. The method for measuring the hydroxyl value is described in ASTM D4274-21—Determination of Hydroxyl Numbers of Polyols.

### DETAILED DESCRIPTION

According to a first aspect of the invention, a reactive mixture for making a soft elastic TPU with a softening point above 80 °C and below 140 °C and an elastic recovery above 92% is disclosed. Said reactive mixture comprising combining at an isocyanate index in the range 90-110 at least following ingredients:
An isocyanate composition comprising at least one isocyanate compound and wherein the isocyanate composition has a number average isocyanate functionality in the range of 1.8 up to 2.2, and
At least one high molecular weight isocyanate-reactive compound having a number average molecular weight >1500 g/mol, having an average degree of branching of greater than 0.4 to less than or equal to 0.8, preferably in the range 0.4 to 0.6 wherein the degree of branching is calculated as the amount of hydrocarbon side chains per polyester (or polyether) unit present in the polyurethane backbone and a number average hydroxyl functionality in the range 1.9 up to 2.1, and
At least one chain extender compound having a number average molecular weight in the range 60-400 g/mol, preferably selected from Hydroquinone Bis (2-hydroxyethyl) Ether (HQEE) and/or compounds corresponding to the formula HO—(CH₂)ₙ—OH wherein n=2, 3, 4, 6, and
Optionally further additives such as a surfactant, UV-stabilizers, catalysts, processing aids, fire retardants and/or mixtures thereof, and
Wherein the molar ratio of chain extender compounds/high molecular weight isocyanate-reactive compound is higher than 0.28 and below 0.5, the hardblock content of the reactive mixture is below 25% and the amount of chain extender compounds is higher or equal to 1% and below 5% calculated on the total weight of all isocyanate and isocyanate-reactive compounds in the reactive mixture.

The “at least one high molecular weight isocyanate-reactive compound having a number average molecular weight >1500 g/mol, having an average degree of branching of greater than 0.4 to less than or equal to 0.8, preferably in the range 0.4 to 0.6 wherein the degree of branching is calculated as the amount of hydrocarbon side chains per polyester (or polyether) unit present in the polyurethane backbone and a number average hydroxyl functionality in the range 1.9 up to 2.1” may refer to a high molecular weight isocyanate-reactive compound, or one or more high molecular weight isocyanate-reactive compounds, provided that the required number average molecular weight, average degree of branching and number average hydroxyl functionality are satisfied by each high molecular weight isocyanate-reactive compound.

Similarly, the “at least one chain extender compound having a number average molecular weight in the range 60-400 g/mol, selected from Hydroquinone Bis (2-hydroxyethyl) Ether (HQEE) and/or compounds corresponding to the formula HO—(CH₂)ₙ—OH wherein n=2, 3, 4, 6” may refer to a chain extender compound, or one or more chain extender compounds, each of which satisfies the definition of the chain extender compound.

The “molar ratio of chain extender compounds/high molecular weight isocyanate-reactive compound” is calculated based upon all of the chain extender compound(s) present in the reactive mixture which have a number average molecular weight in the range 60-400 g/mol and are selected from Hydroquinone Bis (2-hydroxyethyl) Ether (HQEE) and/or compounds corresponding to the formula HO—(CH₂)ₙ—OH wherein n=2, 3, 4, 6. Likewise, the molar ratio is calculated based upon all of the high molecular weight isocyanate-reactive compound(s) present in the reactive mixture which have a number average molecular weight >1500 g/mol and have an average degree of branching of greater than 0.4 to less than or equal to 0.8, preferably in the range 0.4 to 0.6 wherein the degree of branching is calculated as the amount of hydrocarbon side chains per polyester (or polyether) unit present in the polyurethane backbone and have a number average hydroxyl functionality in the range 1.9 up to 2.1

The amount of chain extender compounds is higher or equal to 1% and below 5% is calculated based upon all of the chain extender compound(s) present in the reactive mixture which have a number average molecular weight in the range 60-400 g/mol and are selected from Hydroquinone Bis (2-hydroxyethyl) Ether (HQEE) and/or compounds corresponding to the formula HO—(CH₂)ₙ—OH wherein n=2, 3, 4, 6.

In one embodiment, all of the high molecular weight isocyanate-reactive compound(s) in the reactive mixture have a number average molecular weight >1500 g/mol, have an average degree of branching of greater than 0.4 to less than or equal to 0.8, preferably in the range 0.4 to 0.6 wherein the degree of branching is calculated as the amount of hydrocarbon side chains per polyester (or polyether) unit present in the polyurethane backbone and a number average hydroxyl functionality in the range 1.9 up to 2.1.

Moreover, in one embodiment, all of the chain extender compound(s) in the reactive mixture have a number average molecular weight in the range 60-400 g/mol, and are selected from Hydroquinone Bis (2-hydroxyethyl) Ether (HQEE) and/or compounds corresponding to the formula HO—(CH₂)ₙ—OH wherein n=2, 3, 4, 6.

According to embodiments, the hardblock content of the reactive mixture is below 20%, preferably below 19%, more preferably in the range 15-18%.

According to embodiments, the molar ratio of chain extender compounds/high molecular weight isocyanate-reactive compound in the reactive mixture is in the range 0.29-0.49.

According to embodiments, the amount of chain extender compounds in the reactive mixture is in the range 1%-4.99%, preferably in the range 2% up to 4% calculated on the total weight of all isocyanate and isocyanate-reactive compounds in the reactive mixture.

According to embodiments, the isocyanate compound in the reactive mixture is selected from the group comprising diphenylmethane diisocyanate, preferably selected from 4,4′-diphenylmethane diisocyanate. Alternatively, the isocyanate compound in the reactive mixture is selected from and/or may further comprise 4,4′-dibenzyldiisocyanate, 3,3′-dimethyl diphenyl 4,4′-diisocyanate, isophorone diisocyanate, 1,5-naphtylene diisocyanate, toluene diisocyanate (2,4′ & 2,6′), phenylene diisocyanate, xylene diisocyanate, 1,6-hexamethylene diisocyanate, cyclohexyl diisocyanate, 1,3-bis(isocyanatomethyl)cyclohexane, 4,4′-dicyclohexylmethane diisocyanate, and mixtures thereof.

According to embodiments, the high molecular weight isocyanate reactive compounds in reactive mixture are selected from polyester diols (including polycaprolactone polyols), polyether diols, having a number average hydroxyl functionality in the range 1.9 up to 2.1, preferably in the range 1.95 up to 2.05 and a number average molecular weight in the range 1500 g/mol up to 10000 g/mol, preferably in the range 1800 g/mol up to 8000 g/mol, more preferably in the range 2000 g/mol up to 6000 g/mol.

According to preferred embodiments, the high molecular weight isocyanate reactive compound in reactive mixture is selected from 3-methyl-1,5-pentanediol adipate polyester polyol or poly(tetramethylene ether) glycol having a number average molecular weight in the range 1500-6000 g/mol, preferably in the range 1800-3000 g/mol, more preferably in the range 1800-2200 g/mol.

According to preferred embodiments the chain extender is selected from HQEE in an amount of ≥1.4 wt % and below 5 wt % calculated on the total weight of all isocyanate and isocyanate-reactive compounds in the reactive mixture.

According to another preferred embodiment the chain extender is selected from butanediol (BDO).

According to embodiments, other conventional ingredients (additives and/or auxiliaries) may be added to the reactive mixture according to the invention. These include, but are not limited to, catalysts, surfactants, flame proofing agents, plasticizers, diluents, microspheres, antioxidants, antistatic agents, fillers, pigments, stabilizers and the like.

According to embodiments, suitable catalysts accelerate in particular the reaction between the NCO groups of the diisocyanates and the iso-reactive groups of the iso-reactive compounds and are selected from those known in the prior art such as metal salt catalysts, such as organotins, and amine compounds, such as triethylenediamine (TEDA), N-methylimidazole, 1,2-dimethylimidazole, N-methylmorpholine, N-ethylmorpholine, triethylamine, N,N′-dimethylpiperazine, 1,3,5-tris(dimethylaminopropyl) hexahydrotriazine, 2,4,6-tris(dimethylaminomethyl) phenol, N-methyldicyclohexylamine, pentamethyldipropylene triamine, N-methyl-N′-(2-dimethylamino)-ethyl-piperazine, tributylamine, pentamethyldiethylenetriamine, hexamethyltriethylenetetramine, heptamethyltetraethylenepentamine, dimethylaminocyclohexylamine, pentamethyldipropylene triamine, triethanolamine, dimethylethanolamine, bis(dimethylaminoethyl) ether, tris(3-dimethylamino) propylamine, or its acid blocked derivatives, and the like, as well as any mixture thereof. The catalyst compound should be present in the reactive mixture in a catalytically effective amount, generally from about 0 to 5% by weight, preferably 0 to 2% by weight, most preferably 0 to 1% by weight, based on total weight of all reactive ingredients used.

According to preferred embodiments, the reactive mixture comprises an isocyanate composition comprising >95 wt % 4,4′-diphenylmethane diisocyanate, preferably >98 wt % 4,4′-diphenylmethane diisocyanate, a high molecular weight isocyanate-reactive compound selected from 3-methyl-1,5-pentanediol adipate polyester polyol having a number average molecular weight of about 2000 g/mol and a number average hydroxyl functionality in the range 1.8 up to 2.1, preferably in the range 1.95 up to 2.05 and a chain extender compound selected from Hydroquinone Bis (2-hydroxyethyl) Ether (HQEE).

The current invention also provides a method for making the soft elastomeric TPU according to the invention by combining the ingredients of the above disclosed reactive mixture at an isocyanate index in the range 90-110, more preferably at an isocyanate index from 95 up to 110, more preferably at an isocyanate index from 98 up to 108.

According to embodiments, the method for making the soft elastomeric TPU according to the invention is selected from a batch process or via reactive extrusion.

The soft thermoplastic polyurethane (TPU) material according to the invention has very good elastic recovery (>92%) in combination with low softening point (>80 °C and <140 °C) and low processing temperatures.

According to embodiments, the TPU material according to the invention has an elastic recovery (after 3 cycles of 100% elongation with 15 seconds lag time) of more than 92%, preferably more than 95%.

The soft elastomeric TPU material according to the invention can be used for example and not being limited as an adhesive coating in sew free apparel, in textile, in footwear, in carpets, in furniture coverings, in automotive, in household appliances.

### Examples

### Chemicals Used:

| | |
|---|---|
| Polyester | 3-Methyl-1,5-pentanediol Adipate, Mn 2000, |
| polyol 1 | (average degree of branching = 0.5) |
| Polyester | Ethylene glycol/Diethylene glycol Adipate, |
| polyol 2 | Mn 1810, (average degree of branching = 0) |
| Polyester | 2-Butyl-2-ethyl-1,3-propanediol Adipate, |
| polyol 3 | Mn 2040, (average degree of branching = 1) |
| Polyester | 3-Methyl-1,5-pentanediol Adipate, Mn 5000, |
| polyol 4 | (average degree of branching = 0.5) |
| Chain extender | HQEE |
| Isocyanate | 4,4′-MDI available as Suprasec ® 1306 and |
| | Suprasec ® 1102 from Huntsman |
| Catalyst | Stannous octoate |

Soft elastic TPU materials were produced via a batch process, and via reactive extrusion. In both processes, a blend of the polyol component and chain extender at elevated temperature was used. The temperature of the blend was adjusted to the melting point of the chain extender, and mechanically mixed to ensure a homogeneous mixture of two liquid components. If required, additives/processing aids were added to the blend.

The softening point of the resulting TPU materials was determined via TMA from 25 °C to 150 °C at 10 °C/min and 0.1N, and/or via a rheological oscillation protocol from −10 °C to 160 °C at 5 °C/min and 1 Hz using a 25 mm plate-plate configuration. In the latter method the G′-G″ cross-over temperature was defined as the softening point of the material.

The elastic recovery was measured after 3 cycles of 100% elongation with 15 sec lag time (dimension samples 20*1*0.1 (1*w*t) cm).

### Batch Production Process

A homogeneous blend of polyol/chain extender was prepared at 110 °C (in case of HQEE). A calculated amount of this preheated polyol/chain extender blend was weighed into a reaction vessel. A calculated amount of Suprasec® 1306 isocyanate that was preheated at 50 °C was then added to the reaction vessel under continuous stirring. An amount of catalyst was added to the reaction mixture to ensure a mixing time of 20-30 sec. The reaction mixture was stirred at about 1000 rpm, and then poured in a tray that was preheated at 120 °C. The reaction mixture was allowed to cure for 2 h in an oven at 120 °C, and was then post-cured for 16 h in an oven at 90 °C.

### Reactive Extrusion Production Process

In this process, the reactive components were fed to a twin screw reactive extruder via 4 separate product streams at specific volume ratios as defined by the TPU formulations. The 4 product streams were: a) a polyol/chain extender blend at 110 °C, b) Suprasec 1102 isocyanate at 50 °C, c) liquid additives at ambient temperature, d) a catalyst solution at ambient temperature. Additives that were solid at ambient temperature, were mixed in the polyol/chain extender blend. The reacted polymer melt was pelletized under water, and the pellets were dried at 60 °C for 16 h.

A range of materials with varying amounts of high molecular weight polyol and chain extender (HQEE) were produced at isocyanate index 100 or 104 via a batch process (see Table 1).

TABLE 1

| | Example 1 (via a batch |
|---|---|
| | process) |
| Polyester polyol 1 (g) | 84.00 |
| HQEE Chain extender(g) | 2.43 |
| 4,4′-MDI Isocyanate (g) | 13.57 |
| Stannous octoate Catalyst (g) | 0.008 |
| Blend temperature (°C) | 110 |
| Isocyanate temperature (°C) | 50 |
| Mixing time (s) | 25 |
| Polyester polyol 1 Mn | 2000 |
| CE/polyol mole ratio | 0.292 |
| Hard block content (%) | 16 |
| Isocyanate index (%) | 100 |
| G′-G″ cross-over (°C) | 101 |
| Elastic recovery/100% Tensile Set (%) | 95.6/4.4 |

A range of materials with a variation in concentration of chain extender (HQEE), and isocyanate index was produced via a reactive extrusion (see Table 2).

TABLE 2

| | 2 | 3 | 4 | 5 |
|---|---|---|---|---|
| Polyester polyol 1 (g) | 83.316 | 83.541 | 82.440 | 82.555 |
| HQEE Chain | 2.430 | 2.437 | 2.910 | 2.914 |
| extender (g) | | | | |
| 4,4′-MDI Isocyanate (g) | 13.479 | 13.245 | 13.975 | 13.855 |
| Additive package (g) | 0.700 | 0.700 | 0.600 | 0.600 |
| Stannous octoate | 0.008 | 0.008 | 0.008 | 0.008 |
| catalyst (g) | | | | |
| Blend temperature (°C) | 110 | 110 | 110 | 110 |
| Isocyanate temperature | 50 | 50 | 50 | 50 |
| (°C) | | | | |
| Polyester polyol 1 Mn | 2000 | 2000 | 2000 | 2000 |
| CE/polyol mole ratio | 0.295 | 0.295 | 0.357 | 0.357 |
| Hard block content (%) | 16 | 16 | 17 | 17 |
| Isocyanate index (%) | 100 | 98 | 100 | 99 |
| TMA softening range | 85-112 | 79-106 | 96-124 | 97-118 |
| (°C) | | | | |
| TMA peak = softening | 101 | 97 | 113 | 109 |
| point (°C) | | | | |
| G′-G″ cross-over | 102 | 99 | 106 | 103 |
| (°C) | | | | |
| Elastic recovery/100% | 93.0/7.0 | 92.1/7.9 | 95.3/4.7 | 94.8/5.2 |
| Tensile Set (%) | | | | |

TABLE 3

| | Example | | |
|---|---|---|---|
| | 6 | 7 | 8 |
| Polyester polyol 1 (g) | 81.446 | 81.684 | 81.212 |
| Chain extender HQEE (g) | 3.404 | 3.414 | 3.394 |
| Isocyanate (g) | 14.475 | 14.226 | 14.721 |
| Additive package (g) | 0.600 | 0.600 | 0.600 |
| Stannous octoate Catalyst (g) | 0.008 | 0.008 | 0.008 |
| Blend temperature (°C) | 110 | 110 | 110 |
| Isocyanate temperature (°C) | 50 | 50 | 50 |
| Polyester polyol 1 Mn | 2000 | 2000 | 2000 |
| CE/polyol mole ratio | 0.422 | 0.422 | 0.422 |
| Hard block content (%) | 18 | 18 | 18 |
| Isocyanate index (%) | 100 | 98 | 102 |
| TMA softening range (°C) | 98-123 | 95-114 | 99-126 |
| TMA peak = softening point (°C) | 112 | 110 | 114 |
| G′-G″ cross-over (°C) | 118 | 116 | 129 |
| Elastic recovery/100% | 95.3/4.7 | 95.1/4.9 | 96.3/3.7 |
| Tensile Set (%) | | | |

Comparative samples were produced via a batch process.

TABLE 4

Comparative Example

| | C1 | C2 |
|---|---|---|
| Polyester polyol 2 (g) | 83.030 | — |
| Polyester polyol 3 (g) | — | 84.183 |
| HQEE Chain extender (g) | 3.432 | 2.432 |
| 4,4′-MDI Isocyanate (g) | 14.538 | 13.384 |
| Stannous octoate Catalyst (g) | 0.010 | 0.005 |
| Blend temperature (°C) | 110 | 110 |
| Isocyanate temperature (°C) | 50 | 50 |
| Mixing time (s) | 25 | 25 |
| Polyester polyol Mn | 1810 | 2040 |
| CE/polyol mole ratio | 0.267 | 0.297 |
| Hard block content (%) | 17 | 16 |
| Degree of branching polyol | 0 | 1 |
| Isocyanate index (%) | 100 | 100 |
| TMA softening range (°C) | — | — |
| TMA peak = softening point (°C) | — | — |
| G′-G″ cross-over (°C) | 81 | 63 |
| Elastic recovery/100% Tensile Set (%) | 85.4/14.6 | 25.0/75.0 |

The following comparative samples were produced via a batch process.

TABLE 5

| | Comparative Example | | |
|---|---|---|---|
| | C3 | C4 | C5 |
| Polyester polyol 1 (g) | — | — | 74.542 |
| Polyester polyol 4 (g) | 85.000 | 80.000 | — |
| BDO Chain extender (g) | 2.846 | 4.236 | 4.238 |
| 4,4′-MDI Isocyanate (g) | 12.154 | 15.764 | 21.220 |
| Stannous octoate Catalyst (g) | 0.040 | 0.040 | 0.033 |
| Blend temperature (°C) | 80 | 75 | 75 |
| Isocyanate temperature (°C) | 50 | 50 | 50 |
| Mixing time (s) | 25 | 25 | 25 |
| Polyester polyol Mn | 5000 | 5000 | 2000 |
| CE/polyol mole ratio | 1.86 | 2.9 | 1.26 |
| Hard block content (%) | 15 | 20 | 25.5 |
| Degree of branching polyol | 0.5 | 0.5 | 0.5 |
| Isocyanate index (%) | 100 | 100 | 100 |
| G′-G″ cross-over (°C) | 150 | 170 | 150 |

1. A reactive mixture for making a soft elastic TPU with a softening point below 140 °C and a tensile elastic recovery above 92%, said reactive mixture comprising at least following ingredients, wherein the reactive mixture has an isocyanate index in the range 90-110:
An isocyanate composition comprising at least one isocyanate compound and wherein the isocyanate composition has a number average isocyanate functionality in the range of 1.8 up to 2.2, and
At least one high molecular weight isocyanate-reactive compound having a number average molecular weight >1500 g/mol, having an average degree of branching of greater than 0.4 to less than or equal to 0.8 calculated as the amount of hydrocarbon side chains per polyester (or polyether) unit present in the polyurethane backbone and a number average hydroxyl functionality in the range 1.9 up to 2.1, and
At least one chain extender compound having a number average molecular weight in the range 60-400 g/mol and selected from Hydroquinone Bis (2-hydroxyethyl) Ether (HQEE) and/or compounds corresponding to the formula HO—(CH₂)ₙ—OH wherein n=2, 3, 4 or 6, and
Optionally further additives such as a surfactant, UV-stabilizers, anti-oxidants, catalysts, processing aids, fire retardants and/or mixtures thereof, and
Wherein the molar ratio of chain extender compounds/high molecular weight isocyanate-reactive compound is higher than 0.28 and below 0.5, the hardblock content of the reactive mixture is below 25% and the amount of chain extender compounds is higher or equal to 1% and below 5% calculated on the total weight of all isocyanate and isocyanate-reactive compounds in the reactive mixture.

2. The reactive mixture according to claim 1 wherein the hardblock content of the reactive mixture is below 20%.

3. The reactive mixture according to claim 1 wherein the isocyanate compound is selected from the group comprising diphenylmethane diisocyanate, 4,4′-dibenzyldiisocyanate, 3,3′-dimethyl diphenyl 4,4′-diisocyanate, isophorone diisocyanate, 1,5-naphtylene diisocyanate, toluene diisocyanate (2,4′ & 2,6′), phenylene diisocyanate, xylene diisocyanate, 1,6-hexamethylene diisocyanate, cyclohexyl diisocyanate, 1,3-bis(isocyanatomethyl)cyclohexane, 4,4′-dicyclohexylmethane diisocyanate and mixtures thereof.

4. The reactive mixture according to claim 1 wherein the high molecular weight isocyanate reactive compounds are selected from polyester diols, polyether diols, polycarbonate polyols and/or polyester polyether polyols having a number average hydroxyl functionality in the range 1.9 up to 2.1 and a number average molecular weight in the range 1500 g/mol up to 10000 g/mol.

5. The reactive mixture according to claim 1 wherein the high molecular weight isocyanate reactive compound is selected from 3-methyl-1,5-pentanediol adipate polyester polyol or poly(tetramethylene ether) glycol having a number average molecular weight in the range 1800-5000 g/mol.

6. The reactive mixture according to claim 1 wherein the chain extender is selected from HQEE in an amount of ≥1.4 wt % and below 5 wt % calculated on the total weight of all isocyanate and isocyanate-reactive compounds in the reactive mixture.

7. The reactive mixture according to claim 1 wherein the chain extender is selected from butanediol (BDO).

8. A soft elastic TPU made using the reactive mixture according to claim 1 wherein said TPU has a softening point higher than 80 °C and below 140 °C and a tensile elastic recovery above 95%.

9. A method for making a soft elastomeric TPU comprising combining at an isocyanate index from 90-110:
An isocyanate composition comprising at least one isocyanate compound and wherein the isocyanate composition has a number average isocyanate functionality in the range of 1.8 up to 2.2, and
At least one high molecular weight isocyanate-reactive compound having a number average molecular weight >1500 g/mol, having an average degree of branching of greater than 0.4 to less than or equal to 0.8 calculated as the amount of hydrocarbon side chains per polyester (or polyether) unit present in the polyurethane backbone and a number average hydroxyl functionality in the range 1.9 up to 2.1, and
At least one chain extender compound having a number average molecular weight in the range 60-400 g/mol and selected from Hydroquinone Bis (2-hydroxyethyl) Ether (HQEE) and/or compounds corresponding to the formula HO—(CH₂)ₙ—OH wherein n=2, 3, 4 or 6, and
Optionally further additives such as a surfactant, UV-stabilizers, anti-oxidants, catalysts, processing aids, fire retardants and/or mixtures thereof, and
wherein the molar ratio of chain extender compounds/high molecular weight isocyanate-reactive compound is higher than 0.28 and below 0.5, the hardblock content is below 25% and the amount of chain extender compounds is higher or equal to 1% and below 5% calculated on the total weight of all isocyanate and isocyanate-reactive compounds in the soft elastomeric TPU.

10. A soft elastic TPU made using the reactive mixture according to claim 1, wherein the soft elastic TPU has an elastic recovery of more than 92%.

11. An adhesive comprising the soft elastic TPU of claim 10, wherein the adhesive is applied to at least one of sew free apparel, textiles, footwear, carpets, furniture coverings, automotive parts, and household appliances.
